(19) United States
(12) Patent Application Publication
(10) Pub. No.: US 2017/0235409 A1
(43) Pub. Date: Aug. 17, 2017

(54) WEARABLE DEVICE AND METHOD OF OPERATING WEARABLE DEVICE

(71) Applicant: SAMSUNG ELECTRONICS CO., LTD., Suwon-si (KR)

(72) Inventor: Min-Seok CHAE, Suwon-si (KR)

(21) Appl. No.: 15/395,095

(22) Filed: Dec. 30, 2016

(30) Foreign Application Priority Data
Feb. 12, 2016 (KR) 10-2016-0016264

(51) Int. Cl. G06F 3/041; G06F 3/0485; G06F 3/0484; G06F 1/16

(52) U.S. Cl. CPC G06F 3/0416; G06F 1/163; G06F 3/0412; G06F 3/0485; G06F 3/04845; G06F 2203/04806

(57) ABSTRACT

A wearable electronic device may include: a display unit comprising a display included in a body of the wearable electronic device; a touch sensor module comprising touch sensing circuitry located to surround the display unit and configured to detect a touch; and a processor configured to perform a preset operation based on a start position of the touch detected by the touch sensing circuitry and a movement direction of the touch.

### CROSS-REFERENCE TO RELATED APPLICATION

This application is based on and claims priority under 35 U.S.C. §119 to Korean Application Serial No. 10-2016-0016264, which was filed in the Korean Intellectual Property Office on Feb. 12, 2016, the content of which is incorporated by reference herein in its entirety.

### TECHNICAL FIELD

The present disclosure relates generally to a wearable electronic device and an operation method thereof.

### BACKGROUND

Various electronic devices recently used for real life have become high-tech. Particularly, as a smart phone market has rapidly grown, various electronic devices having some or all of functions of the smart phone are being released.

Such electronic devices include electronic devices such as a smart phone and a smart TV and, particularly, wearable electronic devices which can be worn on a body like a wearable watch and wearable glasses haven been recently developed.

The wearable electronic device (for example, the wearable watch) may be configured to be worn on the wrist (left or right wrist) of a user using the wearable electronic device and may have key buttons on the outside of a main body or a watch strap.

Accordingly, the user may search for and select a menu for executing a desired function through a small number of key buttons.

Further, according to the development of technology, functions of the wearable electronic device have increased and menus for performing controls corresponding to the functions also have increased, so that various means for controlling the menus are being developed.

A wearable electronic device has a difficulty in executing a desired function through a small number of input means.

For example, when a touch sensor module included in the wearable electronic device has a circular form, rotation directions thereof are limited, so that it is difficult to intuitively switch a screen.

### SUMMARY

Various example embodiments of the present disclosure may provide a wearable electronic device and an operation method of a wearable electronic device which may provide various functions based on a start position of a touch input into a touch sensor module and a rotation direction corresponding to a movement of the touch.

A wearable electronic device according to an example embodiment of the present disclosure provided to address the aforementioned problems or other problems may include: a display unit comprising a display included in a body of the wearable electronic device; a touch sensor module including touch sensing circuitry located to surround the display and configured to detect a touch; and a processor configured to perform a preset operation based on a start position of the touch detected by the touch sensing circuitry of the touch sensor module and a movement direction of the touch.

A wearable electronic device according to an example embodiment of the present disclosure may include: a display unit comprising a display included in a body of the wearable electronic device; a touch sensor module comprising touch sensing circuitry located to surround the display and configured to detect a touch; a rotation detection unit comprising rotation detection circuitry and coupled to the body to be rotatable, the rotation detection unit being located at a position corresponding to the touch sensor module, and configured to detect a rotation; and a processor configured to perform a preset operation based on a start position of the touch detected by the touch sensing circuitry of the touch sensor module and a direction of the rotation detected by the rotation detection unit.

An method of operating a wearable electronic device according to an example embodiment of the present disclosure may include: detecting a touch by touch sensing circuitry of a touch sensor module located to surround a display unit included in a body of the wearable electronic device; determining a start position of the touch detected by the touch sensing circuitry of the touch sensor module; determining a movement direction of the touch; and performing a function corresponding to a currently executed application based on the start position and the movement direction of the touch.

An method of operating a wearable electronic device according to an example embodiment of the present disclosure may include: detecting a touch by touch sensing circuitry of a touch sensor module located to surround a display unit included in a body of the wearable electronic device; detecting a rotation by rotation detection circuitry of a rotation detection unit physically coupled to the body to be rotatable and located at a position corresponding to the touch sensor module; determining a start position of the touch detected by the touch sensor module; determining a direction of the rotation detected by the rotation detection unit; and performing a function corresponding to a currently executed application based on the start position of the touch and the rotation direction.

According to various example embodiments of the present disclosure, by controlling a preset operation based on a start position of a touch input into a touch sensor module of a wearable electronic device and a movement direction of the touch, a user can intuitively execute functions such as screen switching performed based on the movement direction of the touch of the touch sensor module in the wearable electronic device.

Further, according to various example embodiments of the present disclosure, by performing a preset operation based on a start position of a touch input into a touch sensor module of a wearable electronic device, a number of touches, and a movement direction of the touch, the wearable electronic device can effectively execute various functions.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a block diagram illustrating an example electronic device within a network environment according to various example embodiments of the present disclosure;

FIG. 2 is a block diagram illustrating an example wearable electronic device according to an example embodiment of the present disclosure;

FIG. 3 is a block diagram illustrating an example wearable electronic device according to another example embodiment of the present disclosure;

FIG. 4 is a block diagram illustrating an example wearable electronic device according to another example embodiment of the present disclosure;

FIGS. 5A and 5B are plan views of an example wearable electronic device according to an example embodiment of the present disclosure;

FIG. 5C is a perspective view of an example wearable electronic device according to an example embodiment of the present disclosure;

FIG. 6 is a flowchart illustrating an example method of operating the wearable electronic device according to an example embodiment of the present disclosure;

FIG. 7 is a flowchart illustrating an example method of operating the wearable electronic device according to an example embodiment of the present disclosure;

FIG. 8 is a diagram illustrating an example screen for an operation based on a touch start position of the wearable electronic device according to an example embodiment of the present disclosure;

FIG. 9 is a diagram illustrating an example of a screen for an operation based on a touch start position of the wearable electronic device according to an example embodiment of the present disclosure;

FIG. 10 is a diagram illustrating an example screen for an operation based on a touch start position of the wearable electronic device according to an example embodiment of the present disclosure;

FIG. 11 is a diagram illustrating an example of a screen for an operation based on a touch start position of the wearable electronic device according to an example embodiment of the present disclosure;

FIG. 12 is a diagram illustrating an example of a screen for an operation based on a touch start position of the wearable electronic device according to an example embodiment of the present disclosure;

FIG. 13 is a diagram illustrating an example screen for an operation based on a touch start position of the wearable electronic device according to an example embodiment of the present disclosure;

FIG. 14 is a diagram illustrating an example of a screen for an operation based on a touch start position of the wearable electronic device according to an example embodiment of the present disclosure;

FIG. 15 is a diagram illustrating an example of a screen for an operation based on a touch start position of the wearable electronic device according to an example embodiment of the present disclosure;

FIG. 16 is a diagram illustrating an example of a screen for an operation based on a touch start position of the wearable electronic device and a number of touches according to an example embodiment of the present disclosure;

FIG. 17 is a diagram illustrating an example of a screen for an operation based on a touch start position of the wearable electronic device and a number of touches according to an example embodiment of the present disclosure;

FIG. 18 is a diagram illustrating an example screen for an operation based on a touch start position of the wearable electronic device according to an example embodiment of the present disclosure;

FIG. 19 is a diagram illustrating an example of a screen for an operation based on a touch start position of the wearable electronic device according to an example embodiment of the present disclosure;

FIG. 20 is a diagram illustrating an example of a screen for an operation based on a touch start position of the wearable electronic device and a number of touches according to an example embodiment of the present disclosure;

FIG. 21 is a diagram illustrating an example of a screen for an operation based on a touch start position of the wearable electronic device and a number of touches according to an example embodiment of the present disclosure;

FIG. 22 is a diagram illustrating an example of a screen for an operation based on a touch start position of the wearable electronic device and a number of touches according to an example embodiment of the present disclosure;

FIG. 23 is a diagram illustrating an example of a screen for an operation based on a touch start position of the wearable electronic device and a number of touches according to an example embodiment of the present disclosure;

FIG. 24 is a block diagram illustrating an example electronic device according to various example embodiments of the present disclosure; and

FIG. 25 is a block diagram illustrating an example program module according to various example embodiments of the present disclosure.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be understood to cover various modifications, equivalents, and/or alternatives of example embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may refer, for example, to a situation in which the device, together with other devices or components, “is able to”. For example, the phrase “processor adapted (or configured) to perform A, B, and C” may refer, for example, to processing circuitry, a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even if terms are defined in this disclosure the terms are not to be interpreted as excluding embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like, but is not limited thereto. According to various embodiments, the wearable device may include at least one of an accessory type (e.g., a watch, a ring, a bracelet, an anklet, a necklace, a glasses, a contact lens, or a Head-Mounted Device (HIVID)), a fabric or clothing integrated type (e.g., an electronic clothing), a body-mounted type (e.g., a skin pad, or tattoo), and a bio-implantable type (e.g., an implantable circuit), or the like, but is not limited thereto.

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. In various embodiments, the electronic device may be a combination of one or more of the aforementioned various devices. According to some embodiments, the electronic device may also be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. In the present disclosure, the term “user” may indicate a person using an electronic device or a device (e.g., an artificial intelligence electronic device) using an electronic device.

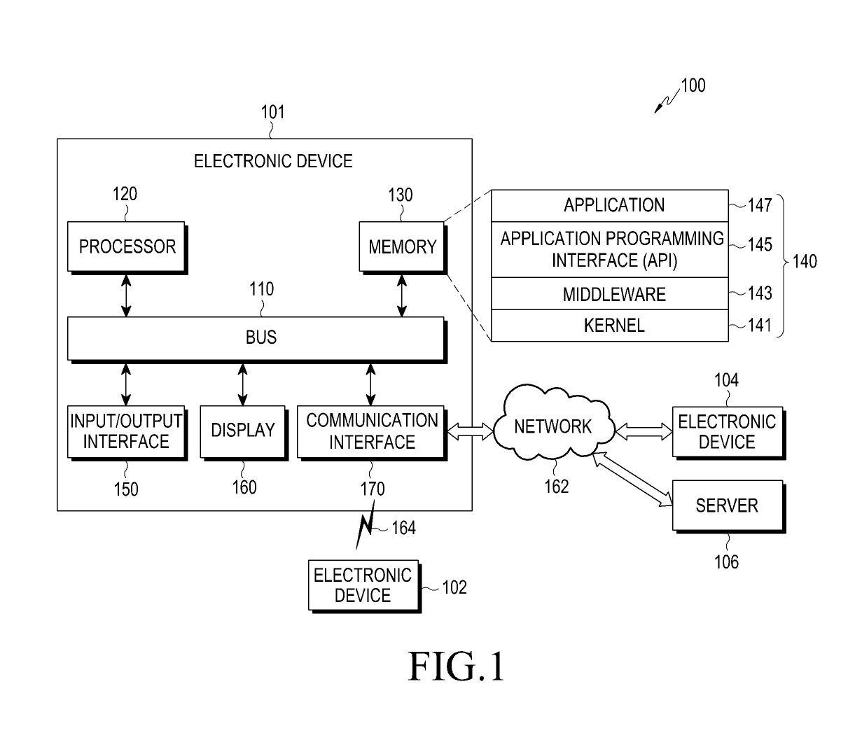

FIG. 1 is a block diagram illustrating an example electronic device within a network environment according to various example embodiments of the present disclosure.

Referring to FIG. 1, an electronic device 101 within a network environment 100 according to various example embodiments will be described. The electronic device 101 may include a bus 110, a processor (e.g., including processing circuitry) 120, a memory 130, an input/output interface (e.g., including input/output circuitry) 150, a display 160, and a communication interface (e.g., including communication circuitry) 170. In some embodiments, the electronic device 101 may omit at least one of the elements, or may further include other elements.

The bus 110 may include, for example, a circuit that interconnects the elements 110 to 170 and delivers communication (for example, a control message and/or data) between the elements 110 to 170.

The processor 120 may include various processing circuitry, such as, for example, and without limitation, one or more of a Central Processing Unit (CPU), an Application Processor (AP), and a Communication Processor (CP). The processor 120, for example, may carry out operations or data processing relating to the control and/or communication of at least one other element of the electronic device 101.

The memory 130 may include a volatile and/or non-volatile memory. The memory 130 may store, for example, instructions or data relevant to at least one other element of the electronic device 101. According to an embodiment, the memory 130 may store software and/or a program 140. The program 140 may include a kernel 141, middleware 143, an Application Programming Interface (API) 145, and/or application programs (or “applications”) 147. At least some of the kernel 141, the middleware 143, and the API 145 may be referred to as an Operating System (OS).

In this document, the application may be referred to as an app or an application.

For example, the kernel 141 may control or manage the system resources (for example, the bus 110, the processor 120, the memory 130, and the like) that are used to execute operations or functions implemented in the other programs (for example, the middleware 143, the API 145, and the application programs 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data.

Furthermore, the middleware 143 may process one or more task requests, which are received from the application programs 147, according to priorities thereof. For example, the middleware 143 may assign priorities for using the system resources (for example, the bus 110, the processor 120, the memory 130, and the like) of the electronic device 101 to one or more of the application programs 147. For example, the middleware 143 may perform scheduling or load balancing on the one or more task requests by processing the one or more task requests according to the priorities assigned to the one or more application programs.

The API 145, which is an interface through which the applications 147 control functions provided from the kernel 141 or the middleware 143, may include, for example, at least one interface or function (for example, an instruction) for file control, window control, image processing, text control, and the like.

The input/output interface 150 may include various input/output circuitry and function as, for example, an interface that may forward instructions or data, which is input from a user or another external device, to the other element(s) of the electronic device 101. Furthermore, the input/output interface 150 may output instructions or data, which are received from the other element(s) of the electronic device 101, to the user or the external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display, or the like, but is not limited thereto. The display 160 may display, for example, various types of contents (for example, text, images, videos, icons, symbols, and the like) for a user. The display 160 may include a touch screen and may receive, for example, a touch, gesture, proximity, or hovering input using an electronic pen or the user's body part.

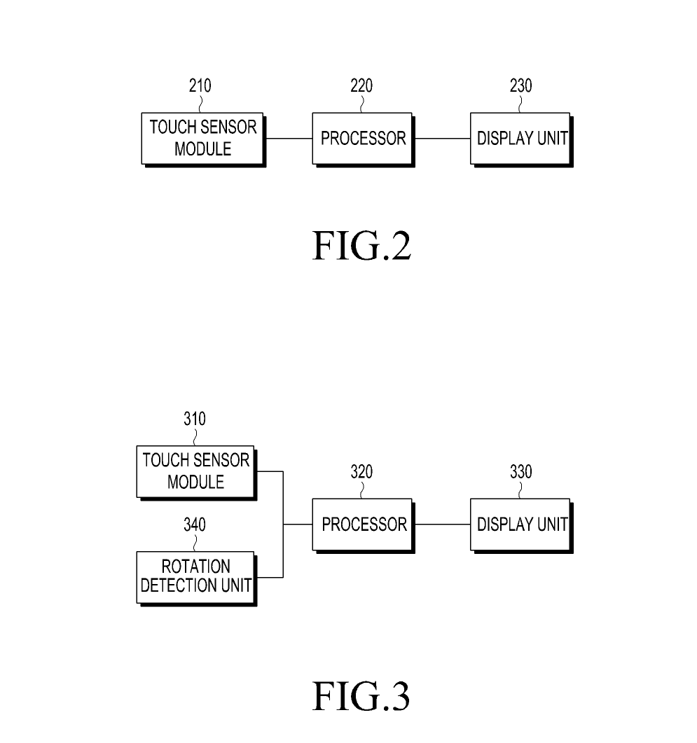

According to various embodiments of the present disclosure, the display 160 may be the same as a display unit 230 described below through FIG. 2.

The communication interface 170 may include various communication circuitry configured to establish communication, for example, between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may use, for example, at least one of Long Term Evolution (LTE), LTE-Advance (LTE-A), Code Division Multiple Access (CDMA), Wideband CDMA (WCDMA), Universal Mobile Telecommunications System (UNITS), WiBro (Wireless Broadband), Global System for Mobile Communications (GSM), and the like, as a cellular communication protocol. In addition, the wireless communication may include, for example, short range communication 164. The short range communication 164 may include, for example, at least one of Wi-Fi, Bluetooth, Near Field Communication (NFC), Global Navigation Satellite System (GNSS), and the like. The GNSS may include at least one of, for example, a Global Positioning System (GPS), a Global navigation satellite system (Glonass), a Beidou navigation satellite system (hereinafter, referred to as “Beidou”), and Galileo (European global satellite-based navigation system). Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), a Plain Old Telephone Service (POTS), and the like. The network 162 may include at least one of a communication network such as a computer network (for example, a LAN or a WAN), the Internet, and a telephone network.

Each of the first and second external electronic devices 102 and 104 may be of a type identical to or different from that of the electronic device 101. According to an embodiment, the server 106 may include a group of one or more servers. According to various embodiments, all or some of the operations executed in the electronic device 101 may be executed in another electronic device or a plurality of electronic devices (for example, the electronic devices 102 and 104 or the server 106). According to an embodiment, when the electronic device 101 has to perform some functions or services automatically or in response to a request, the electronic device 101 may request another device (for example, the electronic device 102 or 104 or the server 106) to perform at least some functions relating thereto instead of, or in addition to, performing the functions or services by itself. The other electronic device (for example, the electronic device 102 or 104 or the server 106) may perform the requested functions or the additional functions and may transfer the execution result to the electronic device 101. The electronic device 101 may provide the received result as it is, or may additionally process the received result to provide the requested functions or services. To this end, for example, cloud computing, distributed computing, or client-server computing technology may be used.

FIG. 2 is a block diagram illustrating an example wearable electronic device according to an example embodiment of the present disclosure.

As illustrated in FIG. 2, the wearable electronic device may include a touch sensor module (e.g., including touch sensing circuitry) 210, a processor (e.g., including processing circuitry) 220, and a display unit (e.g., including a display) 230.

The touch sensor module 210 may include various touch sensing circuitry and be located at an edge of the display unit 230 provided on an upper part of the body of the wearable electronic device and, when a user's touch is input, may detect the user's touch.

For example, the touch sensor module 210 may implement a touch surface on borders (edges) of the display unit 230 to make the display unit 230 have various shapes of outlines such as a circle, an oval, and a polygon.

The touch sensor module 210 may be formed in an outline shape corresponding to the outline shape of the display unit 230 or may be formed in the aforementioned various outline shapes regardless of the outline shape of the display unit 230.

The processor 220 may include various processing circuitry configured to perform a preset operation based on a start position of a touch detected by the touch sensor module 210 and a movement direction of the touch.

The movement direction may refer to a movement of the touch in a clockwise direction or a counterclockwise direction based on the start position of the touch.

Further, when a number of touches detected by the touch sensor module 210 is plural, start positions of the touches may be determined individually.

When the start positions of the plurality of touches are determined, movement directions of the touches in a clockwise direction or a counterclockwise direction based on the start positions are determined and then preset operations may be performed based on the plurality of determined start positions of the touches and movement directions of the touches.

The processor 220 may determine the start position of the touch detected by the touch sensor module 210 by using a coordinate value and may also determine the start position of the touch through various methods.

For example, when the start position of the touch is detected using the coordinate value, an orthogonal coordinate type sensor having X-Y coordinates may be disposed in the touch sensor module 210 but the present disclosure is not limited to the aforementioned coordinate type. Accordingly, regardless of a coordinate system or configuration, various touch surfaces or sensors on which coordinates are properly converted may be disposed in the touch sensor module 210.

The touch sensor module 210 may be divided into a plurality of areas and coordinate value ranges may be preset to the plurality of divided areas. The start position of the touch may be determined using one of the plurality of divided areas corresponding to a coordinate value of the start position of the touch.

According to an embodiment, when a user's touch is detected in one of the plurality of touches, the one area may be determined as the start position of the touch. Further, a movement direction of the touch may be determined in a clockwise direction or a counterclockwise direction based on the area in which the user's touch is detected among the plurality of areas.

Accordingly, the processor 220 may perform a preset operation based on the area (that is, start position of the touch) in which the user's touch is detected and the determined movement direction of the touch.

According to an embodiment, when a number of user's touches detected in one of the plurality of areas is plural, the one area may be determined as a start position of the plurality of touches and a number of touches may be determined with respect to each of the plurality of touches. Further, a movement direction of the touch may be determined in a clockwise direction or a counterclockwise direction based on the area in which the user's touch is detected among the plurality of areas.

Accordingly, the processor 220 may perform a preset operation based on the area (that is, start position of the plurality of touches) in which the plurality of user's touches are detected), the number of touches determined in the area in which the touches are detected, and the determined movement direction.

The display unit 230 may be located outside the body of the wearable electronic device and may display a screen on which a preset operation according to a control of the processor 220 is performed.

FIG. 3 is a block diagram schematically illustrating an example wearable electronic device according to another example embodiment of the present disclosure.

As illustrated in FIG. 3, the wearable electronic device may include a touch sensor module (e.g., including touch sensing circuitry) 310, a processor (e.g., including processing circuitry) 320, a display unit (e.g., including a display) 330, and a rotation detection unit (e.g., including rotation detecting circuitry) 340. The touch sensor module 310, the processor 320, and the display unit 330 of FIG. 3 may be configured identically or similarly to the touch sensor module 210, the processor 220, and the display unit 230 of FIG. 2, respectively. Therefore, repeated descriptions of the touch sensor module 310, the processor 320, and the display unit 330 will be omitted.

The rotation detection unit 340 may be physically coupled to the body of the wearable electronic device to be rotatable and may be located at a position corresponding to the touch sensor module 310 to detect a rotation.

The rotation detection unit 340 may include at least one rotatable mechanical element and, when receiving a rotation input from the user, may physically rotate in a clockwise direction or a counterclockwise direction. The rotation detection unit 340 may also include various rotation detecting circuitry.

The touch sensor module 310 may be attached to the rotation detection unit 340 and may be rotated as the rotation detection unit 340 rotates.

According to an embodiment, when the touch sensor module 310 rotates along with the rotation detection unit 340, the processor 320 may determine the start position of the touch detected by the touch sensor module 310 using a coordinate value.

The processor 320 may preset an initial coordinate value of the touch sensor module 310 as a reference coordinate value and compare a coordinate value after the rotation with the reference coordinate value to determine the start position of the touch.

The processor 320 may acquire displacement information based on the physical rotation in a clockwise direction or a counterclockwise direction in accordance with the physical rotation of the rotation detection unit 340 and may determine a rotation direction of the rotation detection unit 340 by using the displacement information based on the physical rotation.

The processor 320 may perform a preset operation based on the determined start position of the touch and the determined rotation direction.

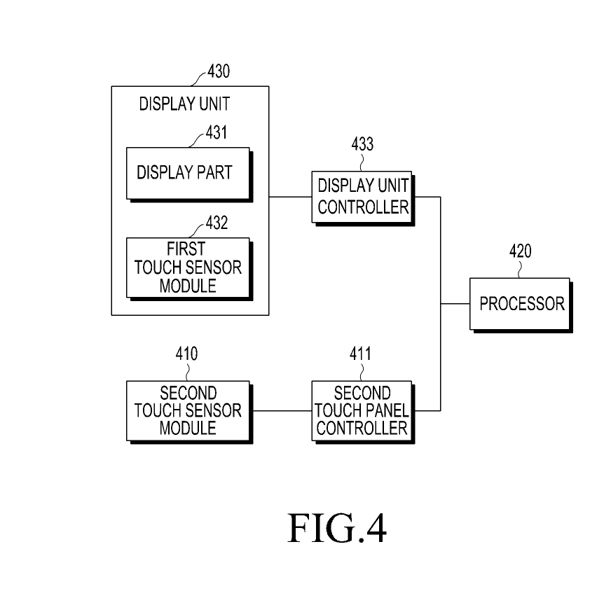

FIG. 4 is a block diagram illustrating an example wearable electronic device according to another example embodiment of the present disclosure.

As illustrated in FIG. 4, the wearable electronic device may include a display unit 430 including a display part 431 and a first touch sensor module (e.g., including touch sensing circuitry) 432, a display unit controller (e.g., including processing circuitry) 433, a second touch sensor module (e.g., including touch sensing circuitry) 410, a second touch sensor module controller (e.g., including processing circuitry) 411, and a processor (e.g., including processing circuitry) 420.

The display unit 430 may be located on an upper part of the body of the wearable electronic device and may display a screen on which a preset operation according to a control of the processor 420 is performed.

The display unit 430 may include only the display part 431 on which the performed preset operation is displayed or may also include the first touch sensor module 432 for detecting a user's touch input.

The second touch sensor module 410 may be located at edges of the display unit 430 and, when a user's touch is input, may detect the user's touch.

For example, the second touch sensor module 410 may implement a touch surface in borders (edges) of the display unit 430 and make the display unit 430 have various shapes of outlines such as a circle, an oval, and a polygon.

The second touch sensor module 410 may be formed in an outline shape corresponding to the outline shape of the display unit 430 or formed in the aforementioned various outline shapes regardless of the outline shape of the display unit 430.

The second touch sensor module controller 411 may determine a start position of the touch detected by the second touch sensor module 420 and a movement direction of the touch.

The second touch sensor module controller 411 may determine the start position of the touch detected by the second touch sensor module 420 by using a coordinate value and determine the start position through other various methods.

According to an embodiment, an operation of determining the start position of the touch and an operation of determining the movement direction of the touch are not performed by the processor 420 instead of the second touch sensor module controller 441.

According to one of the various embodiments of the present disclosure, a wearable electronic device may include: a display unit included in a body of the wearable electronic device; a touch sensor module located to surround the display unit and configured to detect a touch; and a processor that performs a preset operation based on a start position of the touch detected by the touch sensor module and a movement direction of the touch.

According to various embodiments of the present disclosure, the display unit may be a touch screen.

According to various embodiments of the present disclosure, the processor may make a control to perform a preset operation based on a number of touches detected by the touch sensor module.

According to various embodiments of the present disclosure, when the start position of the touch is detected in a left side of a vertical line passing the center of the display unit, the processor may be configured to perform a scroll up operation when the movement direction of the touch is a clockwise direction and to perform a scroll down operation when the movement direction is a counterclockwise direction.

According to various embodiments of the present disclosure, when the start position of the touch is detected in a right side of a vertical line passing the center of the display unit, the processor may be configured to perform a scroll down operation when the movement direction of the touch is a clockwise direction and to perform a scroll up operation when the movement direction is a counterclockwise direction.

According to various embodiments of the present disclosure, when the start position of the touch is detected in an upper side of a horizontal line passing the center of the display unit, the processor may be configured to perform a scroll to right operation when the movement direction of the touch is a clockwise direction and to perform a scroll to left operation when the movement direction is a counterclockwise direction.

According to various embodiments of the present disclosure, when the start position of the touch is detected in a lower side of a horizontal line passing the center of the display unit, the processor may be configured to perform a scroll to left operation when the movement direction of the touch is a clockwise direction and to perform a scroll to right operation when the movement direction is a counterclockwise direction.

According to various embodiments of the present disclosure, when the start position of the touch is detected in a left side of a vertical line passing the center of the display unit, the processor may be configured to perform a volume up operation when the movement direction of the touch is a clockwise direction and to perform a volume down operation when the movement direction is a counterclockwise direction.

According to various embodiments of the present disclosure, when the start position of the touch is detected in a right side of a vertical line passing the center of the display unit, the processor may be configured to perform a volume down operation when the movement direction of the touch is a clockwise direction and to perform a volume up operation when the movement direction is a counterclockwise direction.

According to one of the various embodiments of the present disclosure, a wearable electronic device may include: a display unit included in a body of the wearable electronic device; a touch sensor module located to surround the display unit and configured to detect a touch; a rotation detection unit coupled to the body to be physically rotatable, located at a position corresponding to the touch sensor module, and configured to detect a rotation; and a processor that performs a preset operation based on a start position of the touch detected by the touch sensor module and a direction of the rotation detected by the rotation detection unit.

According to various embodiments of the present disclosure, the display unit may be a touch screen.

According to various embodiments of the present disclosure, the touch sensor module may physically rotate along with the rotation detection unit.

According to various embodiments of the present disclosure, the processor may be configured to perform a preset operation based on a number of touches detected by the touch sensor module.

According to various embodiments of the present disclosure, when a start position of the touch is detected in a left side of a vertical line passing the center of the display unit, the processor may be configured to perform a scroll up operation when the movement direction of the touch is a clockwise direction and to perform a scroll down operation when the movement direction is a counterclockwise direction.

According to various embodiments of the present disclosure, when the start position of the touch is detected in a right side of a vertical line passing the center of the display unit, the processor may be configured to perform a scroll down operation when the movement direction of the touch is a clockwise direction and to perform a scroll up operation when the movement direction is a counterclockwise direction.

According to various embodiments of the present disclosure, when the start position of the touch is detected in an upper side of a horizontal line passing the center of the display unit, the processor may be configured to perform a scroll to right operation when the movement direction of the touch is a clockwise direction and to perform a scroll to left operation when the movement direction is a counterclockwise direction.

According to various embodiments of the present disclosure, when the start position of the touch is detected in a lower side of a horizontal line passing the center of the display unit, the processor may be configured to perform a scroll to left operation when the movement direction of the touch is a clockwise direction and to perform a scroll to right operation when the movement direction is a counterclockwise direction.

According to various embodiments of the present disclosure, when the start position of the touch is detected in a left side of a vertical line passing the center of the display unit, the processor may be configured to perform a volume up operation when the movement direction of the touch is a clockwise direction and to perform a volume down operation when the movement direction is a counterclockwise direction.

According to various embodiments of the present disclosure, when the start position of the touch is detected in a right side of a vertical line passing the center of the display unit, the processor may be configured to perform a volume down operation when the movement direction of the touch is a clockwise direction and to perform a volume up operation when the movement direction is a counterclockwise direction.

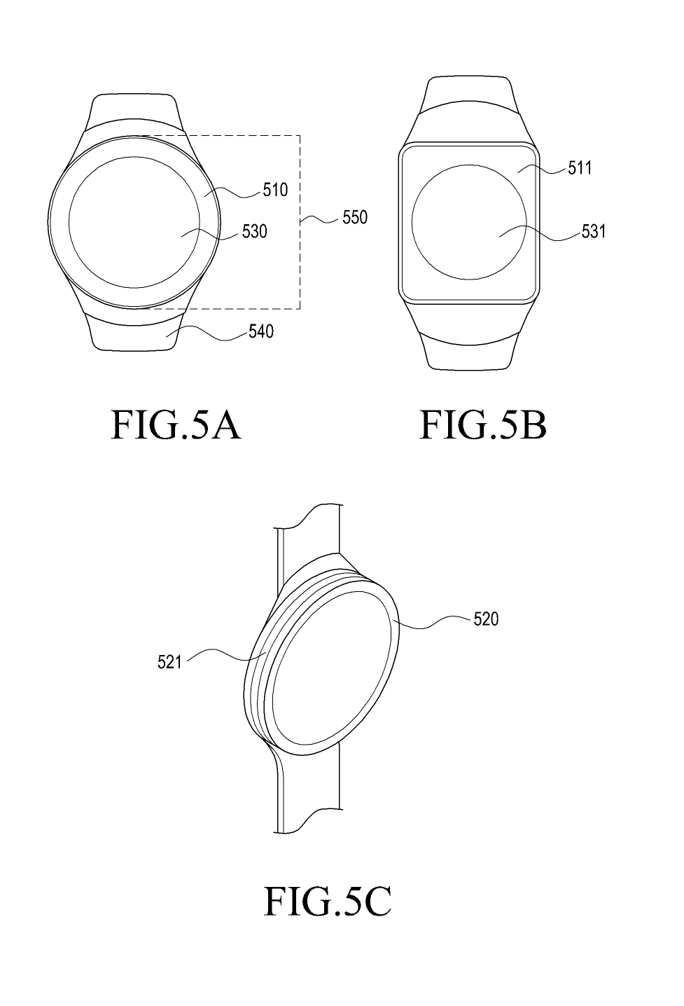

FIGS. 5A and 5B are plan views of an example wearable electronic device according to an example embodiment of the present disclosure.

As illustrated in FIG. 5A, the wearable electronic device may include a display unit 530, a touch sensor module 510, a fixing unit 540, and a body part 550.

Referring to FIG. 5A, although the embodiment of the present disclosure illustrates the display unit 530 having a substantially circular outline and the touch sensor module 510 having a substantially circular outline, which is located on edges of the display unit 530, the touch sensor module 510 may be formed to have various shapes of outlines such as an oval and a polygon.

For example, as illustrated in FIG. 5B, although the outline of the display part 531 is a circle, the outline of the touch sensor module 511 may be a polygon.

The fixing unit 540 may be physically coupled to the touch sensor module 510 and serve a role of fixing the touch sensor module 510 and the display unit 530 to connect them with a body part of the user. Although the fixing unit 540 is formed to face itself centered on the circular touch sensor module 510 and the display unit 530 in an embodiment of the present disclosure, the fixing unit 540 may be formed in various shapes or at various locations.

The display part 531 and the touch sensor module 511 may be located on the body part 550.

FIG. 5C is a perspective view of the wearable electronic device according to an embodiment of the present disclosure.

Referring to FIG. 5C, the wearable electronic device according to the embodiment of the present disclosure may include a rotation detection unit 521, and a touch sensor module 520 attached to an upper surface of the rotation detection unit 521.

The rotation detection unit 521 may include at least one rotatable mechanical element and, when receiving a rotation input from the user, may physically rotate in a clockwise direction or a counterclockwise direction.

According to an embodiment, when the rotation detection unit 521 physically rotates, the touch sensor module 520 attached to the upper surface of the rotation detection unit 521 may rotate along with the rotation detection unit 511.

When the touch sensor module 520 is located inside the body of the wearable electronic device to be separated from a lower surface of the rotation detection unit 521, the touch sensor module 520 may not physically rotate even though the rotation detection unit 521 physically rotates.

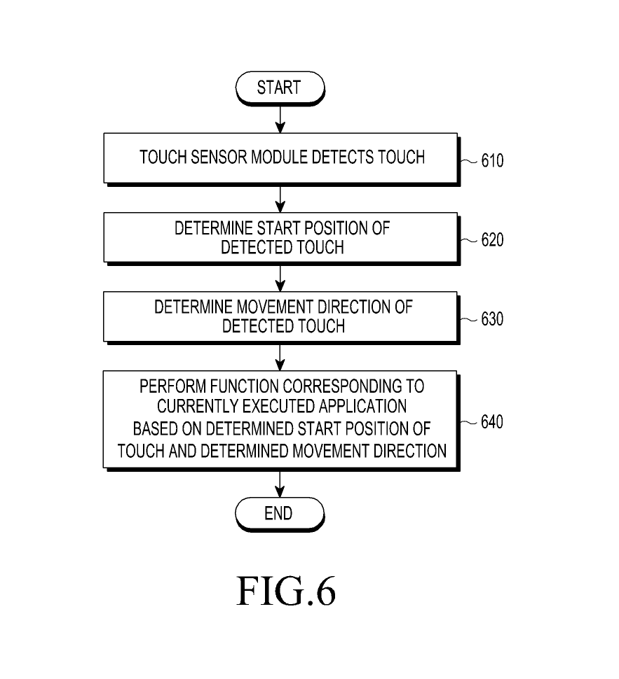

FIG. 6 is a flowchart illustrating an example method of operating the wearable electronic device according to an example embodiment of the present disclosure.

Referring to FIG. 6, in step 610, the touch sensor module located to surround the display unit included in the body of the wearable electronic device may perform an operation of detecting a touch. In step 620, an operation of determining a start position of the touch detected by the touch sensor module may be performed. In step 630, an operation of determining a movement direction of the detected touch may be performed. In step 640, an operation of performing a function corresponding to a currently executed application based on the determined start position of the touch and the determined movement direction of the touch may be performed.

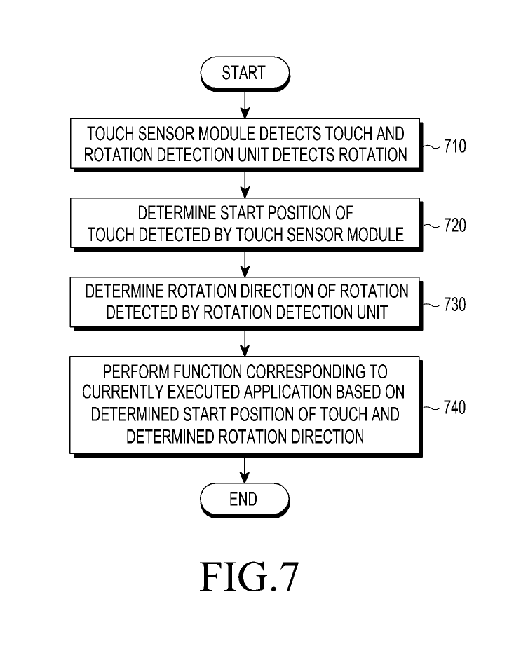

FIG. 7 is a flowchart illustrating an example method of operating the wearable electronic device according to an example embodiment of the present disclosure.

Referring to FIG. 7, in step 710, the touch sensor module located to surround the display unit included in the body of the wearable electronic device may perform an operation of detecting a touch and the rotation detection unit may perform an operation of detecting a rotation. In step 720, an operation of determining a start position of the touch detected by the touch sensor module may be performed. In step 730, the rotation detection unit may detect a rotation direction of the rotation detected by the rotation detection unit. In step 740, an operation of performing a function corresponding to a currently executed application based on the determined start position of the touch and the determined movement (e.g., rotation) direction of the touch may be performed.

According to one of the various embodiments of the present disclosure, an operation method of a wearable electronic device may include: an operation of detecting a touch by a touch sensor module located to surround a display unit included in a body of the wearable electronic device; an operation of determining a start position of the touch detected by the touch sensor module; an operation of determining a movement direction of the touch; and an operation of performing a function corresponding to a currently executed application based on the start position and the movement direction of the touch.

According to various embodiments of the present disclosure, the display unit may be a touch screen.

According to various embodiments of the present disclosure, the operation of determining the start position of the touch detected by the touch sensor module may include an operation of determining a number of touches detected by the touch sensor module.

According to various embodiments of the present disclosure, the operation of determining the start position of the touch detected by the touch sensor module may include an operation of determining the start position of the touch detected in one of a plurality of divided areas of the touch sensor module.

According to various embodiments of the present disclosure, when the start position of the touch is detected in a left side of a vertical line passing the center of the display unit, the operation of performing the function may include an operation of performing a scroll up function when the movement direction of the touch is a clockwise direction and an operation of performing a scroll down function when the movement direction is a counterclockwise direction.

According to various embodiments of the present disclosure, when the start position of the touch is detected in a right side of a vertical line passing the center of the display unit, the operation of performing the function may include an operation of performing a scroll down function when the movement direction of the touch is a clockwise direction and an operation of performing a scroll up function when the movement direction is a counterclockwise direction.

According to various embodiments of the present disclosure, when the start position of the touch is detected in an upper side of a horizontal line passing the center of the display unit, the operation of performing the function may include an operation of performing a scroll to right function when the movement direction of the touch is a clockwise direction and an operation of performing a scroll to left function when the movement direction is a counterclockwise direction.

According to various embodiments of the present disclosure, when the start position of the touch is detected in a lower side of a horizontal line passing the center of the display unit, the operation of performing the function may include an operation of performing a scroll to left function when the movement direction of the touch is a clockwise direction and an operation of performing a scroll to right function when the movement direction is a counterclockwise direction.

According to various embodiments of the present disclosure, when the start position of the touch is detected in a left side of a vertical line passing the center of the display unit, the operation of performing the function may include an operation of performing a volume up function when the movement direction of the touch is a clockwise direction and an operation of performing a volume down function when the movement direction is a counterclockwise direction.

According to various embodiments of the present disclosure, when the start position of the touch is detected in a right side of a vertical line passing the center of the display unit, the operation of performing the function may include an operation of performing a volume down function when the movement direction of the touch is a clockwise direction and an operation of performing a volume up function when the movement direction is a counterclockwise direction.

According to one of the various embodiments of the present disclosure, an operation method of a wearable electronic device may include: an operation of detecting a touch by a touch sensor module located to surround a display unit included in a body of the wearable electronic device; an operation of detecting a rotation by a rotation detection unit physically coupled to the body to be rotatable and located at a position corresponding to the touch sensor module; an operation of determining a start position of the touch detected by the touch sensor module; an operation of determining a direction of the rotation detected by the rotation detection unit; and an operation of performing a function corresponding to a currently executed application based on the start position of the touch and the rotation direction.

According to various embodiments of the present disclosure, the display unit may be a touch screen.

According to various embodiments of the present disclosure, the operation of determining the start position of the touch detected by the touch sensor module may include an operation of determining a number of touches detected by the touch sensor module.

According to various embodiments of the present disclosure, the operation of determining the start position of the touch detected by the touch sensor module may include an operation of determining the start position of the touch detected in one of a plurality of divided areas of the touch sensor module.

According to various embodiments of the present disclosure, when the start position of the touch is detected in a left side of a vertical line passing the center of the display unit, the operation of performing the function may include an operation of performing a scroll up function when the movement direction of the touch is a clockwise direction and an operation of performing a scroll down function when the movement direction is a counterclockwise direction.

According to various embodiments of the present disclosure, when the start position of the touch is detected in a right side of a vertical line passing the center of the display unit, the operation of performing the function may include an operation of performing a scroll down function when the movement direction of the touch is a clockwise direction and an operation of performing a scroll up function when the movement direction is a counterclockwise direction.

According to various embodiments of the present disclosure, when the start position of the touch is detected in an upper side of a horizontal line passing the center of the display unit, the operation of performing the function may include an operation of performing a scroll to right function when the movement direction of the touch is a clockwise direction and an operation of performing a scroll to left function when the movement direction is a counterclockwise direction.

According to various embodiments of the present disclosure, when the start position of the touch is detected in a lower side of a horizontal line passing the center of the display unit, the operation of performing the function may include an operation of performing a scroll to left function when the movement direction of the touch is a clockwise direction and an operation of performing a scroll to right function when the movement direction is a counterclockwise direction.

According to various embodiments of the present disclosure, when the start position of the touch is detected in a left side of a vertical line passing the center of the display unit, the operation of performing the function may include an operation of performing a volume up function when the movement direction of the touch is a clockwise direction and an operation of performing a volume down function when the movement direction is a counterclockwise direction.

According to various embodiments of the present disclosure, when the start position of the touch is detected in a right side of a vertical line passing the center of the display unit, the operation of performing the function may include an operation of performing a volume down function when the movement direction of the touch is a clockwise direction and an operation of performing a volume up function when the movement direction is a counterclockwise direction.

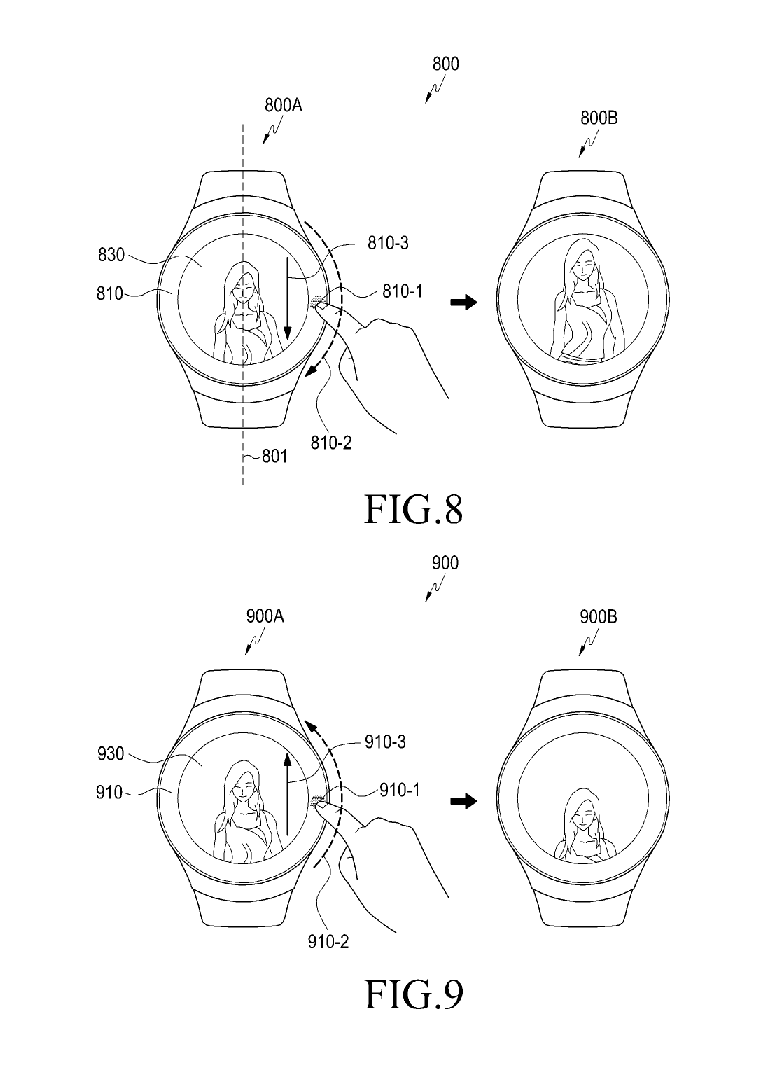

FIG. 8 is a diagram illustrating an example screen for an operation based on a touch start position of the wearable electronic device according to an example embodiment of the present disclosure.

Referring to FIG. 8, when a touch sensor module 810 detects a start position 810-1 of a touch on the right side of a vertical line 801 passing the center of the display unit 830 and a movement direction 810-2 of the detected touch is a clockwise direction, a predetermined operation 810-3 such as scroll down may be performed.

As the predetermined operation 810-3 such as scroll down is performed, a left image 800A displayed on the display unit 830 may be scrolled and a right image 800B may be displayed.

The vertical line 801 may refer, for example, to a straight line pointing to directions of 12 o'clock and 6 o'clock of the watch.

FIG. 9 is a diagram illustrating an example of a screen for an operation based on a touch start position of the wearable electronic device according to an example embodiment of the present disclosure.

Referring to FIG. 9, when a touch sensor module 910 detects a start position 910-1 of a touch in the right side of a vertical line passing the center of the display unit 930 and a movement direction 910-2 of the detected touch is a counterclockwise direction, a predetermined operation 910-3 such as scroll up may be performed.

As the predetermined operation 910-3 such as scroll up is performed, a left image 900A displayed on the display unit 930 may be scrolled and a right image 900B may be displayed.

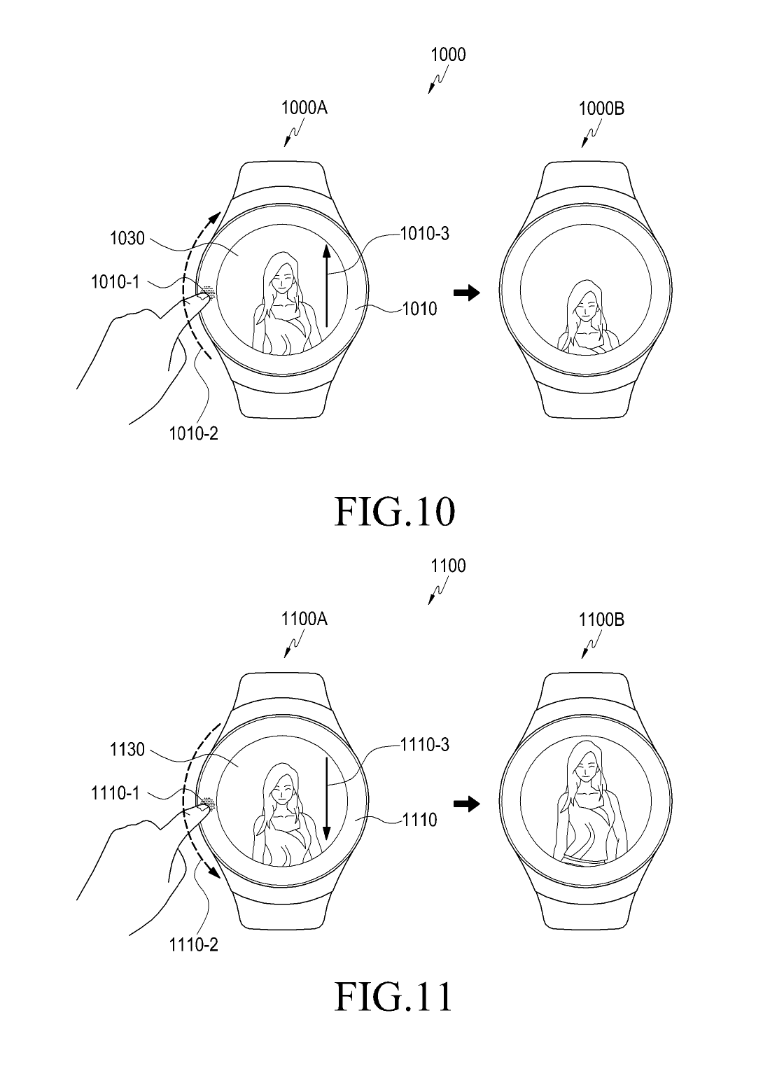

FIG. 10 is a diagram illustrating an example screen for an operation based on a touch start position of the wearable electronic device according to an example embodiment of the present disclosure.

Referring to FIG. 10, when a touch sensor module 1010 detects a start position 1010-1 of a touch in the left side of a vertical line passing the center of the display unit 1030 and a movement direction 1010-2 of the detected touch is a clockwise direction, a predetermined operation 1010-3 such as scroll up may be performed.

As the predetermined operation 1010-3 such as scroll up is performed, a left image 1000A displayed on the display unit 1030 may be scrolled and a right image 1000B may be displayed.

FIG. 11 is a diagram illustrating an example screen for an operation based on a touch start position of the wearable electronic device according to an example embodiment of the present disclosure.

Referring to FIG. 11, when a touch sensor module 1110 detects a start position 1110-1 of a touch in the left side of a vertical line passing the center of the display unit 1130 and a movement direction 1110-2 of the detected touch is a counterclockwise direction, a predetermined operation 1110-3 such as scroll down may be performed.

As the predetermined operation 1110-3 such as scroll down is performed, a left image 1100A displayed on the display unit 1130 may be scrolled and a right image 1100B may be displayed.

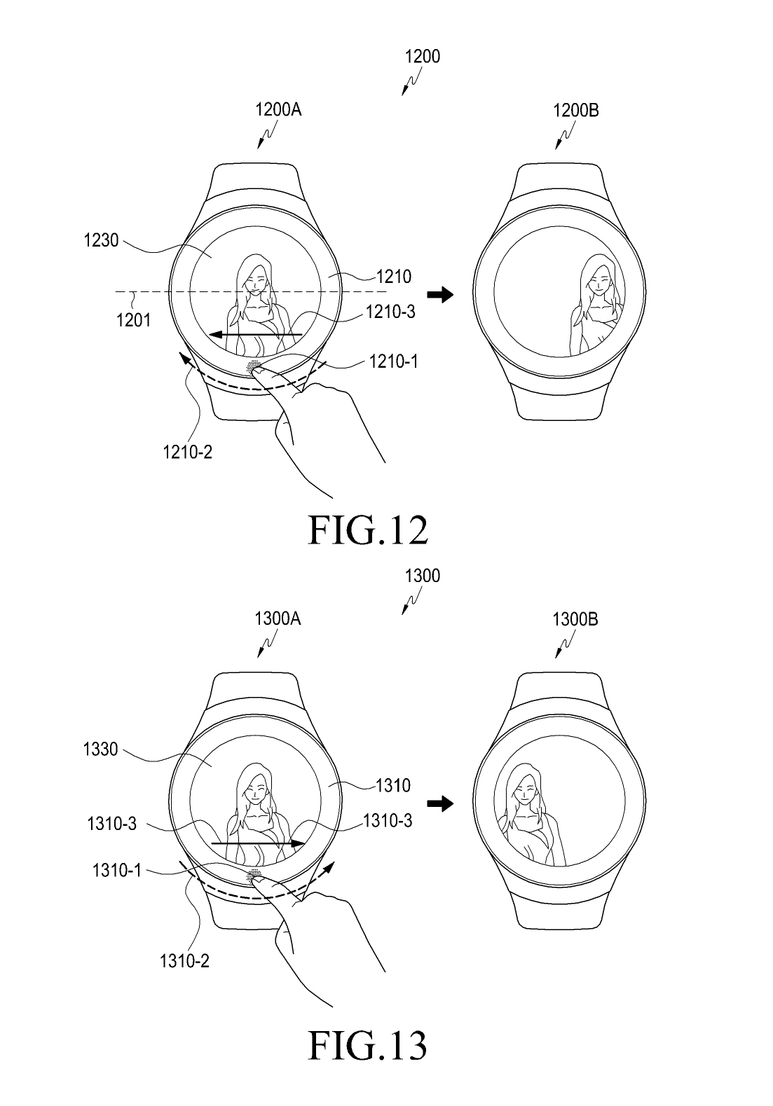

FIG. 12 is a diagram illustrating an example of a screen for an operation based on a touch start position of the wearable electronic device according to an example embodiment of the present disclosure.

Referring to FIG. 12, when a touch sensor module 1210 detects a start position 1210-1 of a touch in the lower side of a horizontal line 1201 passing the center of the display unit 1230 and a movement direction 1210-2 of the detected touch is a clockwise direction, a predetermined operation 1210-3 such as scroll to left may be performed.

As the predetermined operation 1210-3 such as scroll to left is performed, a left image 1200A displayed on the display unit 1230 may be scrolled and a right image 1200B may be displayed.

The horizontal line 1201 may refer, for example, to a straight line pointing to directions of 3 o'clock and 9 o'clock of the watch.

FIG. 13 is a diagram illustrating an example screen for an operation based on a touch start position of the wearable electronic device according to an example embodiment of the present disclosure.

Referring to FIG. 13, when a touch sensor module 1310 detects a start position 1310-1 of a touch in the lower side of a horizontal line passing the center of the display unit 1330 and a movement direction 1310-2 of the detected touch is a counterclockwise direction, a predetermined operation 1310-3 such as scroll to right may be performed.

As the predetermined operation 1310-3 such as scroll to right is performed, a left image 1300A displayed on the display unit 1330 may be scrolled and a right image 1300B may be displayed.

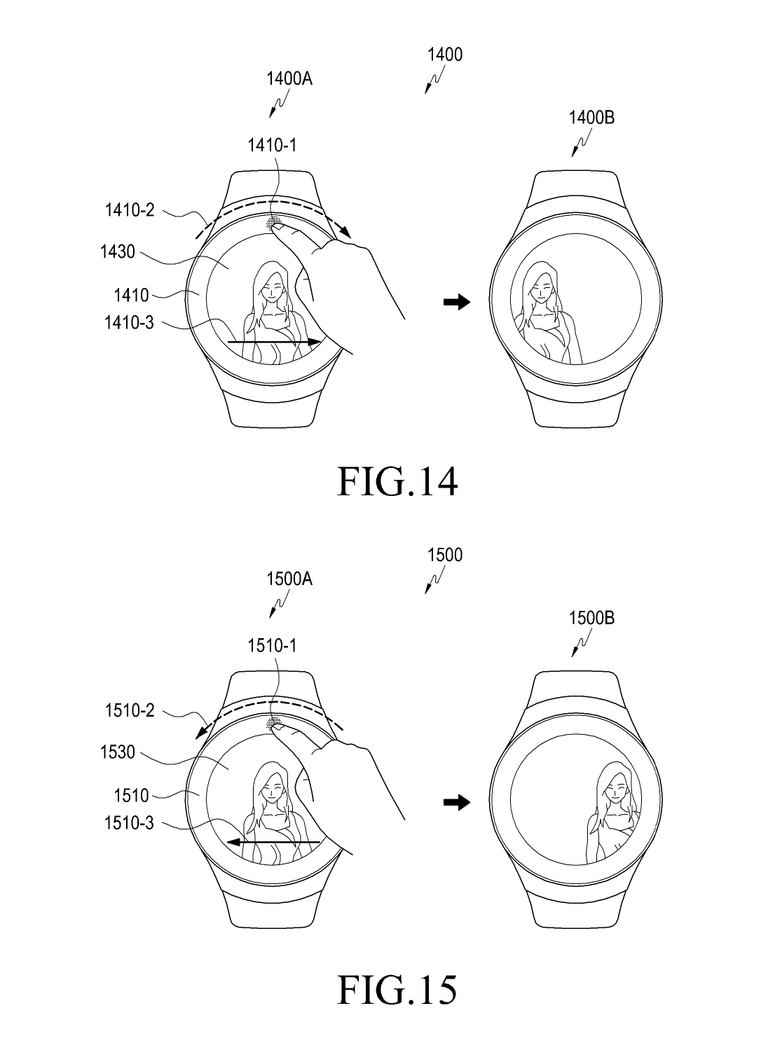

FIG. 14 is a diagram illustrating an example of a screen for an operation based on a touch start position of the wearable electronic device according to an example embodiment of the present disclosure.

Referring to FIG. 14, when a touch sensor module 1410 detects a start position 1410-1 of a touch in the upper side of a horizontal line passing the center of the display unit 1430 and a movement direction 1410-2 of the detected touch is a clockwise direction, a predetermined operation 1410-3 such as scroll to right may be performed.

As the predetermined operation 1410-3 such as scroll to right is performed, a left image 1400A displayed on the display unit 1430 may be scrolled and a right image 1400B may be displayed.

FIG. 15 is a diagram illustrating an example of a screen for an operation based on a touch start position of the wearable electronic device according to an example embodiment of the present disclosure.

Referring to FIG. 15, when a touch sensor module 1510 detects a start position 1510-1 of a touch in the upper side of a horizontal line passing the center of the display unit 1530 and a movement direction 1510-2 of the detected touch is a counterclockwise direction, a predetermined operation 1510-3 such as scroll to left may be performed.

As the predetermined operation 1510-3 such as scroll to left is performed, a left image 1500A displayed on the display unit 1530 may be scrolled and a right image 1500B may be displayed.

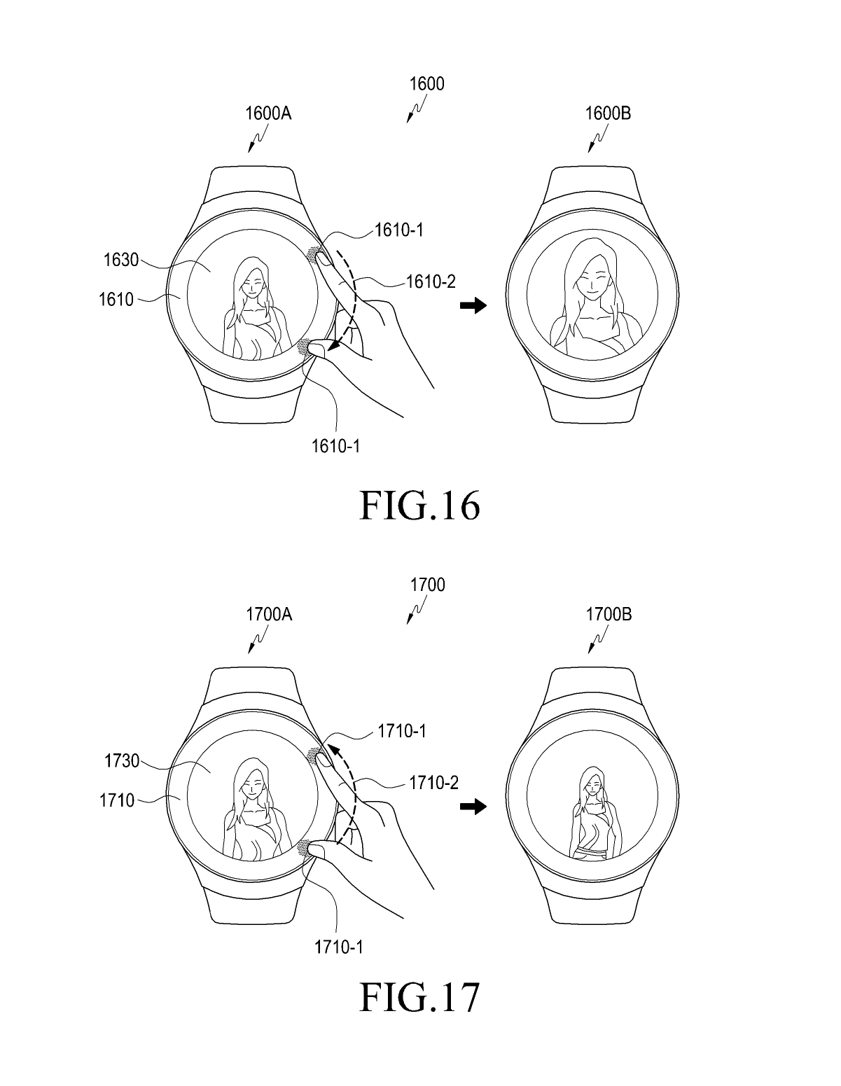

FIG. 16 is a diagram illustrating an example of a screen for an operation based on a touch start position of the wearable electronic device and a number of touches according to an example embodiment of the present disclosure.

Referring to FIG. 16, when a touch sensor module 1610 detects start positions 1610-1 of a plurality of touches in the right side of a vertical line passing the center of the display unit 1630 and a movement direction 1610-2 of the detected touches is a clockwise direction, a predetermined operation 1610-3 such as zoom in may be performed.

As the predetermined operation 1610-3 such as zoom in is performed, a left image 1600A displayed on the display unit 1630 may be zoomed in and a right image 1600B may be displayed.

Based on the starts positions 1610-1 of the plurality of touches and the number of touches, a predetermined operation may be performed based on the movement direction 1610-2 of the plurality of detected touches.

Further, a predetermined operation may be performed based on the movement direction 1610-2 of the plurality of detected touches based on only the number of touches regardless of the start positions 1610-1 of the plurality of touches.

FIG. 17 is a diagram illustrating an example of a screen for an operation based on a touch start position of the wearable electronic device and a number of touches according to an example embodiment of the present disclosure.

Referring to FIG. 17, when a touch sensor module 1710 detects start positions 1710-1 of a plurality of touches in the right side of a vertical line passing the center of the display unit 1730 and a movement direction 1710-2 of the detected touches is a counterclockwise direction, a predetermined operation 1710-3 such as zoom out may be performed.

As the predetermined operation 1710-3 such as zoom out is performed, a left image 1700A displayed on the display unit 1730 may be zoomed out and a right image 1700B may be displayed.

A predetermined operation may be performed based on the movement direction 1710-2 of the plurality of detected touches based on the start positions 1710-1 of the plurality of touches and the number of plurality of touches.

Further, a predetermined operation may be performed based on the movement direction 1710-2 of the plurality of detected touches based on only the number of touches regardless of the start positions 1710-1 of the plurality of touches.

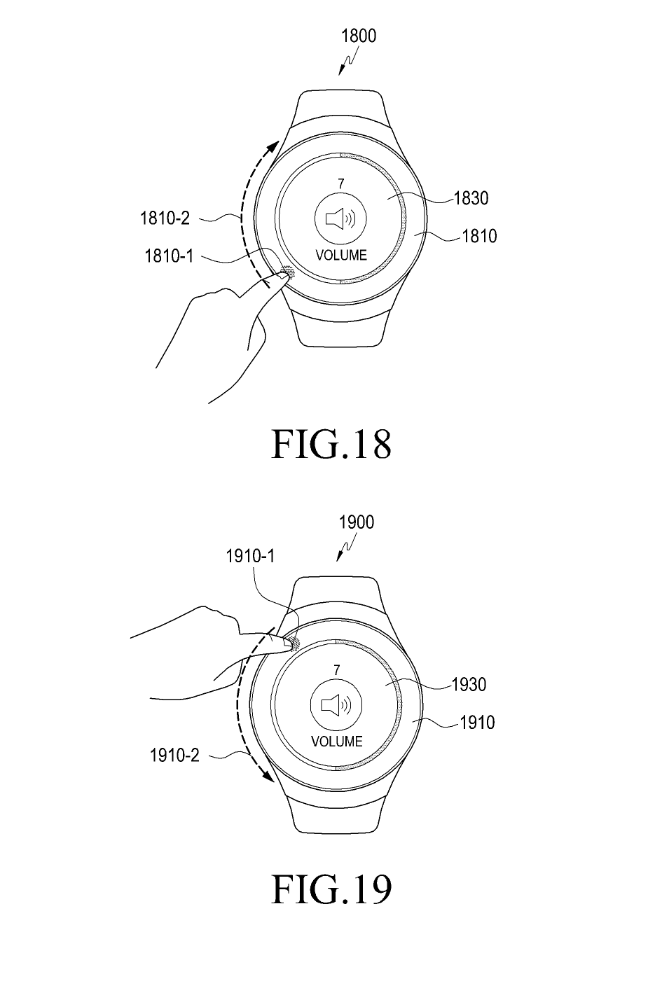

FIG. 18 is a diagram illustrating an example screen for an operation based on a touch start position of the wearable electronic device according to an example embodiment of the present disclosure.

Referring to FIG. 18, when a touch sensor module 1810 detects a start position 1810-1 of a touch in the left side of a vertical line passing the center of the display unit 1830 and a movement direction 1810-2 of the detected touch is a clockwise direction, a predetermined operation such as volume up may be performed.

As the predetermined operation such as volume up is performed, a volume of a currently executed application may be turned up.

FIG. 19 is a diagram illustrating an example of a screen for an operation based on a touch start position of the wearable electronic device according to an example embodiment of the present disclosure.

Referring to FIG. 19, when a touch sensor module 1910 detects a start position 1910-1 of a touch in the left side of a vertical line passing the center of the display unit 1930 and a movement direction 1910-2 of the detected touch is a counterclockwise direction, a predetermined operation such as volume down may be performed.

As the predetermined operation such as volume down is performed, a volume of a currently executed application may be turned down.

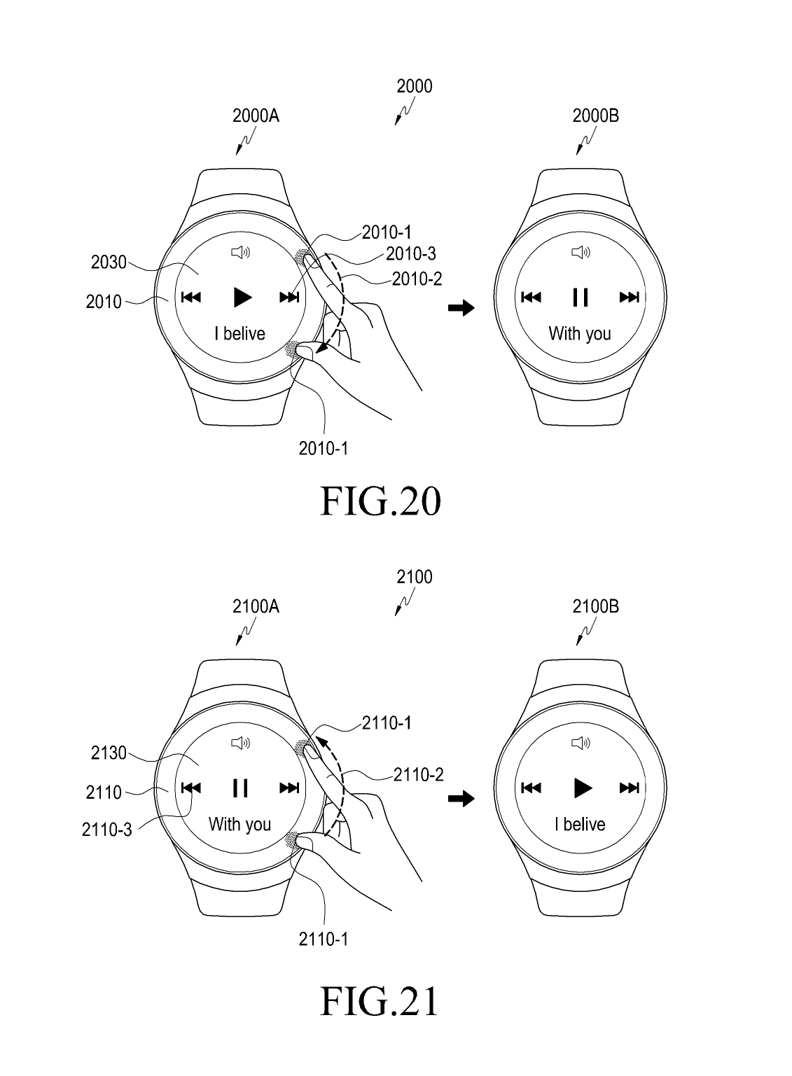

FIG. 20 is a diagram illustrating an example of a screen for an operation based on a touch start position of the wearable electronic device and a number of touches according to an example embodiment of the present disclosure.

Referring to FIG. 20, when a touch sensor module 2010 detects start positions 2010-1 of a plurality of touches in the right side of a vertical line passing the center of the display unit 2030 and a movement direction 2010-2 of the detected touches is a clockwise direction, a predetermined operation 2010-3 such as move to next may be performed.

As the predetermined operation 2010-3 such as move to next is performed, an image 2000A displayed on the display unit 2030 may switch to an image 2000B and currently played music may be stopped and a following song may be played.

A predetermined operation may be performed based on the movement direction 2010-2 of the plurality of detected touches based on the start positions 2010-1 of the plurality of touches and the number of plurality of touches.

Further, a predetermined operation may be performed based on the movement direction 2010-2 of the plurality of detected touches based on only the number of touches regardless of the start positions 2010-1 of the plurality of touches.

FIG. 21 is a diagram illustrating an example of a screen for an operation based on a touch start position of the wearable electronic device and a number of touches according to an example embodiment of the present disclosure.

Referring to FIG. 21, when a touch sensor module 2110 detects start positions 2110-1 of a plurality of touches in the right side of a vertical line passing the center of the display unit 2130 and a movement direction 2110-2 of the detected touches is a counterclockwise direction, a predetermined operation 2110-3 such as move to previous may be performed.

As the predetermined operation 2110-3 such as move to previous is performed, an image 2100A displayed on the display unit 2130 may switch to an image 2100B and currently played music may be stopped and a previous song may be played.

A predetermined operation may be performed based on the movement direction 2110-2 of the plurality of detected touches based on the start positions 2110-1 of the plurality of touches and the number of plurality of touches.

Further, a predetermined operation may be performed based on the movement direction 2110-2 of the plurality of detected touches based on only the number of touches regardless of the start positions 2110-1 of the plurality of touches.

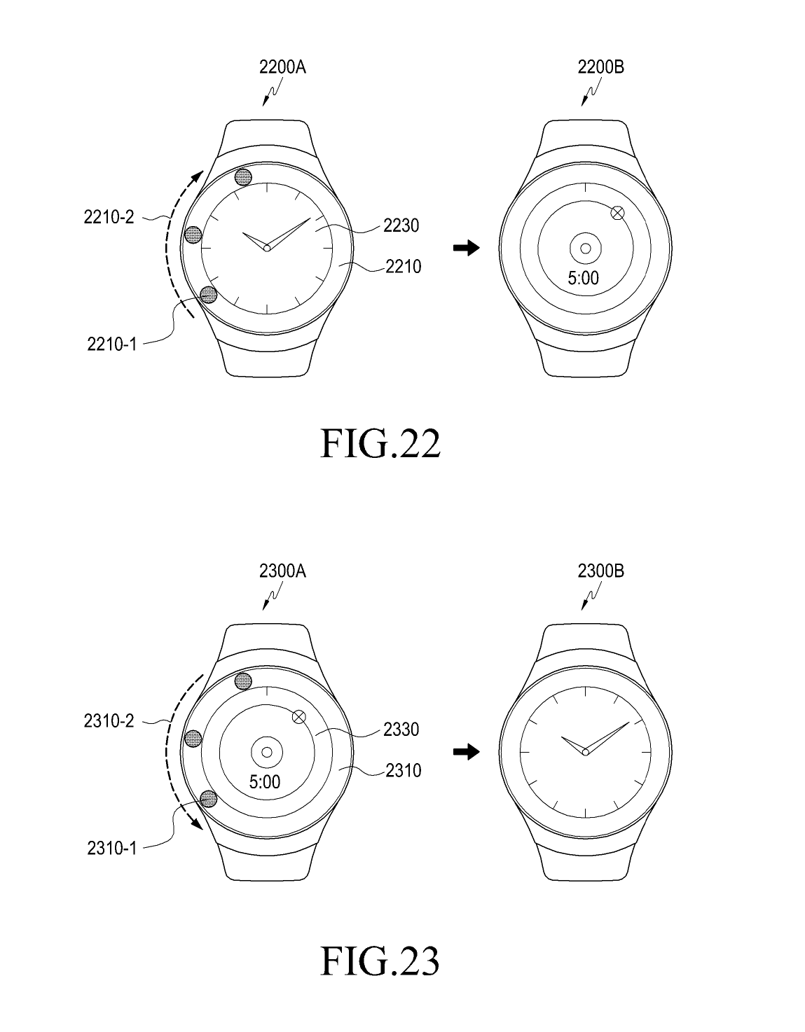

FIG. 22 is a diagram illustrating an example of a screen for an operation based on a touch start position of the wearable electronic device and a number of touches according to an example embodiment of the present disclosure.

Referring to FIG. 22, when a touch sensor module 2210 detects start positions 2210-1 of a plurality of touches in the left side of a vertical line passing the center of the display unit 2230 and a movement direction 2210-2 of the detected touches is a clockwise direction, a predetermined operation such as execution of a recently executed application may be performed.

As the predetermined operation such as the execution of the recently executed application is performed, a home screen 2200A displayed on the display unit 2230 may switch to an application execution screen 2200B.

A predetermined operation 2210-3 may be performed based on the movement direction 2210-2 of the plurality of detected touches based on the start positions 2210-1 of the plurality of touches and the number of plurality of touches.

Further, a predetermined operation may be performed based on the movement direction 2210-2 of the plurality of detected touches based on only the number of touches regardless of the start positions 2210-1 of the plurality of touches.

FIG. 23 is a diagram illustrating an example of a screen for an operation based on a touch start position of the wearable electronic device and a number of touches according to an example embodiment of the present disclosure.

Referring to FIG. 23, when a touch sensor module 2310 detects start positions 2310-1 of a plurality of touches in the left side of a vertical line passing the center of the display unit 2330 and a movement direction 2310-2 of the detected touches is a counterclockwise direction, a predetermined operation such as stopping execution of an application and switching to a home screen may be performed.

As the predetermined operation such as the operation of switching an application execution screen 2300A displayed on the display unit 2330 to the home screen, the execution of the application may be stopped and the application execution screen 2300A may be switched to the home screen 2300B.

A predetermined operation may be performed based on the movement direction 2310-2 of the plurality of detected touches based on the start positions 2310-1 of the plurality of touches and the number of plurality of touches.

Further, a predetermined operation may be performed based on the movement direction 2310-2 of the plurality of detected touches based on only the number of touches regardless of the start positions 2310-1 of the plurality of touches.

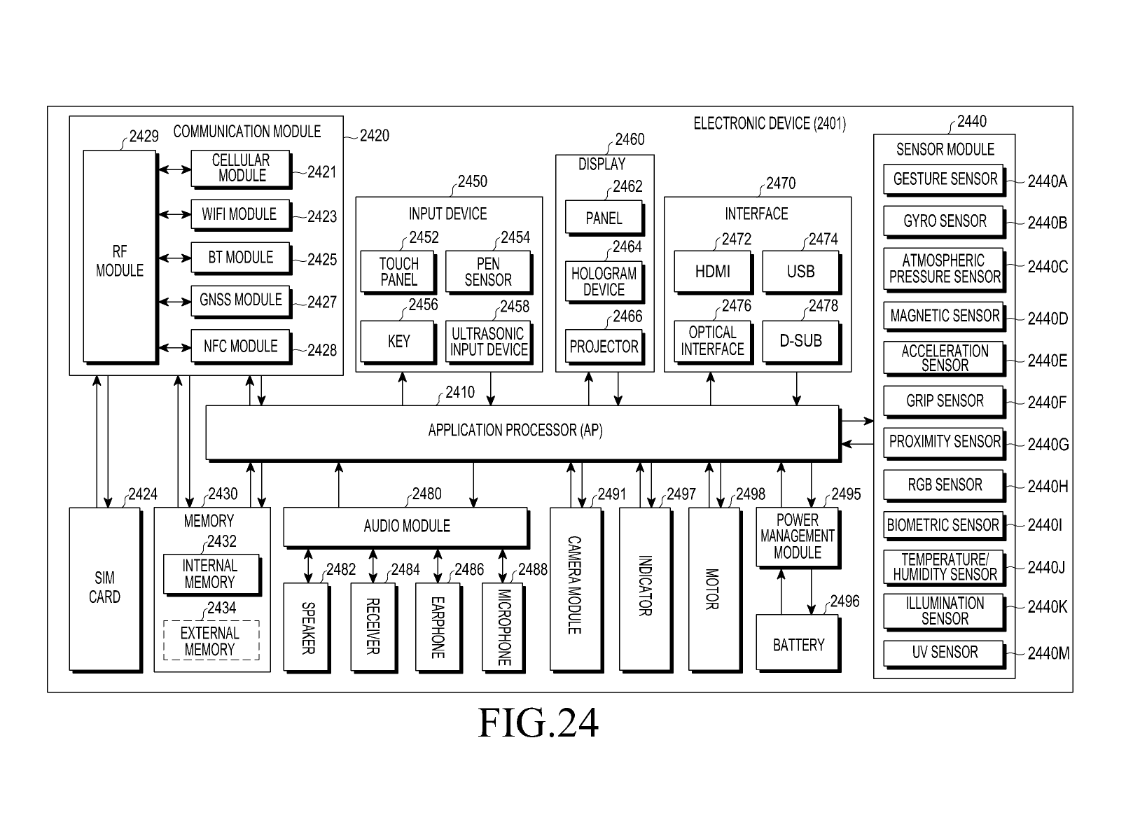

FIG. 24 is a block diagram illustrating an example electronic device 2401 according to various embodiments.

The electronic device 2401 may include, for example, the entirety or a part of the electronic device 101 illustrated in FIG. 1. The electronic device 2401 may include at least one Application Processor (AP) (e.g., including processing circuitry) 2410, a communication module (e.g., including communication circuitry) 2420, a Subscriber Identification Module (SIM) card 2424, a memory 2430, a sensor module 2440, an input device (e.g., including input circuitry) 2450, a display 2460, an interface (e.g., including interface circuitry) 2470, an audio module 2480, a camera module 2491, a power management module 2495, a battery 2496, an indicator 2497, and a motor 2498.

The processor 2410 may include various processing circuitry configured to control a plurality of hardware or software elements connected thereto and may perform various data processing and operations by driving an operating system or an application program. The processor 2410 may be embodied, for example, as various processing circuitry and may be implemented as a System on Chip (SoC). According to an embodiment, the processor 2410 may further include a Graphic Processing Unit (GPU) and/or an image signal processor. The processor 2410 may also include at least some (for example, a cellular module 2421) of the elements illustrated in FIG. 2. The processor 2410 may load, in a volatile memory, instructions or data received from at least one of the other elements (for example, a non-volatile memory) to process the loaded instructions or data, and may store various types of data in the non-volatile memory.

The communication module 2420 may have a configuration equal or similar to that of the communication interface 170 of FIG. 1. The communication module 2420 may include various communication circuitry, such as, for example, and without limitation, a cellular module 2421, a Wi-Fi module 2423, a BT module 2425, a GNSS module 2427 (for example, a GPS module, a Glonass module, a Beidou module, or a Galileo module), an NFC module 2428, and a Radio Frequency (RF) module 2429.

The cellular module 2421 may provide, for example, a voice call, a video call, a text message service, an Internet service, and the like through a communication network. According to an embodiment, the cellular module 2421 may identify and authenticate the electronic device 2401 within a communication network using the subscriber identification module 2424 (for example, a SIM card). According to an embodiment, the cellular module 2421 may perform at least some of the functions that the processor 2410 may provide. According to an embodiment, the cellular module 2421 may include a Communication Processor (CP).

The Wi-Fi module 2423, the BT module 2425, the GNSS module 2427, or the NFC module 2428 may include, for example, a processor for processing data that is transmitted and received through the corresponding module. According to some embodiments, at least some (for example, two or more) of the cellular module 2421, the Wi-Fi module 2423, the BT module 2425, the GNSS module 2427, and the NFC module 2428 may be included in one Integrated Chip (IC) or IC package.

The RF module 2429, for example, may transmit/receive a communication signal (for example, an RF signal). The RF module 2429 may include, for example, a transceiver, a Power Amplifier Module (PAM), a frequency filter, a Low Noise Amplifier (LNA), an antenna, and the like. According to another embodiment, at least one of the cellular module 2421, the Wi-Fi module 2423, the BT module 2425, the GNSS module 2427, and the NFC module 2428 may transmit/receive an RF signal through a separate RF module.

The subscriber identification module 2424 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 2430 (for example, the memory 130) may include, for example, an internal memory 2432 and/or an external memory 2434. The internal memory 2432 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a flash memory (for example, a NAND flash memory or a NOR flash memory), a hard drive, or a Solid State Drive (SSD).

The external memory 2434 may further include a flash drive, for example, a Compact Flash (CF), a Secure Digital (SD), a Micro Secure Digital (Micro-SD), a Mini Secure Digital (Mini-SD), an eXtreme Digital (xD), a Multi-Media Card (MMC), a memory stick, and the like. The external memory 2434 may be functionally and/or physically connected to the electronic device 2401 through various interfaces.

The sensor module 2440 may, for example, measure a physical quantity or detect the operating state of the electronic device 2401 and may convert the measured or detected information into an electrical signal. The sensor module 2440 may include, for example, at least one of a gesture sensor 2440A, a gyro sensor 2440B, an atmospheric pressure sensor 2440C, a magnetic sensor 2440D, an acceleration sensor 2440E, a grip sensor 2440F, a proximity sensor 2440G a color sensor 2440H (for example, a red, green, blue (RGB) sensor), a biometric sensor 2440I, a temperature/humidity sensor 2440J, an illumination sensor 2440K, and an ultraviolet (UV) sensor 2440M. Additionally or alternatively, the sensor module 240A may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 2440 may further include a control circuit for controlling one or more sensors included therein. In some embodiments, the electronic device 2401 may further include a processor configured to control the sensor module 2440 as a part of, or separately from, the processor 2410, and may control the sensor module 2440 while the processor 2410 is in a sleep state.

According to various embodiments of the present disclosure, the touch sensor module may be defined as a meaning including the sensor module 2440.

The input device 2450 may include various input circuitry, such as, for example, and without limitation, a touch panel 2452, a (digital) pen sensor 2454, a key 2456, or an ultrasonic input unit 2458. The touch panel 2452 may use, for example, at least one of a capacitive type, a resistive type, an infrared type, and an ultrasonic type. Furthermore, the touch panel 2452 may further include a control circuit. The touch panel 2452 may further include a tactile layer to provide a tactile reaction to a user.

The (digital) pen sensor 2454 may include, for example, a recognition sheet that is a part of, or separate from, the touch panel. The key 2456 may include, for example, a physical button, an optical key, or a keypad. The ultrasonic input device 2458 may detect ultrasonic waves, which are generated by an input tool, through a microphone (for example, a microphone 288) to identify data corresponding to the detected ultrasonic waves.

The display 2460 (for example, the display 160) may include a panel 2462, a hologram device 2464 or a projector 2466. The panel 2462 may include the same or a similar configuration to the display 160A illustrated in FIG. 1. The panel 2462 may be implemented to be, for example, flexible, transparent, or wearable. The panel 2462, together with the touch panel 2452, may be implemented as one module. The hologram device 2464 may show a three dimensional image in the air by using an interference of light. The projector 2466 may display an image by projecting light onto a screen. The screen may be located, for example, in the interior of, or on the exterior of, the electronic device 2401. According to an embodiment, the display 2460 may further include a control circuit for controlling the panel 2462, the hologram device 2464, or the projector 2466.

According to various embodiments of the present disclosure, the display 160 including the panel 2462 may be used as the same or similar meaning to the display unit. That is, the display unit may be defined as a meaning including the display 160 for displaying specific information and the panel 2462 for receiving a touch input.

The interface 2470 may include various interface circuitry, such as, for example, and without limitation, a High-Definition Multimedia Interface (HDMI) 2472, a Universal Serial Bus (USB) 2474, an optical interface 2476, or a D-subminiature (D-sub) 2478. The interface 2470 may be included, for example, in the communication interface 170 illustrated in FIG. 1. Additionally or alternatively, the interface 2470 may include, for example, a Mobile High-definition Link (MHL) interface, a Secure Digital (SD) card/Multi-Media Card (MMC) interface, or an Infrared Data Association (IrDA) standard interface.

The audio module 2480 may convert, for example, a sound into an electrical signal, and vice versa. At least some elements of the audio module 2480 may be included, for example, in the input/output interface 145 illustrated in FIG. 1. The audio module 2480 may process sound information that is input or output through, for example, a speaker 2482, a receiver 2484, earphones 2486, the microphone 2488, and the like.

The camera module 2491 is a device that can photograph a still image and a moving image. According to an embodiment, the camera module 2491 may include one or more image sensors (for example, a front sensor or a rear sensor), a lens, an Image Signal Processor (ISP), or a flash (for example, an LED or xenon lamp).

The power management module 2495 may manage, for example, the power of the electronic device 2401. According to an embodiment, the power management module 2495 may include a Power Management Integrated Circuit (PMIC), a charger Integrated Circuit (IC), or a battery or fuel gauge. The PMIC may have a wired and/or wireless charging method. Examples of the wireless charging method may include a magnetic resonance method, a magnetic induction method, an electromagnetic wave method, and the like. Additional circuits (for example, a coil loop, a resonance circuit, a rectifier, and the like) for wireless charging may be further included. The battery gauge may measure, for example, the residual amount of the battery 2496 and a voltage, current, or temperature while charging. The battery 2496 may include, for example, a rechargeable battery and/or a solar battery.

The indicator 2497 may indicate a particular state (for example, a booting state, a message state, a charging state, and the like) of the electronic device 2401 or a part (for example, the processor 2410) thereof. The motor 2498 may convert an electrical signal into a mechanical vibration and may generate a vibration, a haptic effect, and the like. Although not illustrated, the electronic device 2401 may include a processing device (for example, a GPU) for supporting a mobile TV. The processing unit for supporting the mobile TV may process media data according to a standard, such as Digital Multimedia Broadcasting (DMB), Digital Video Broadcasting (DVB), MediaFlo™, and the like.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

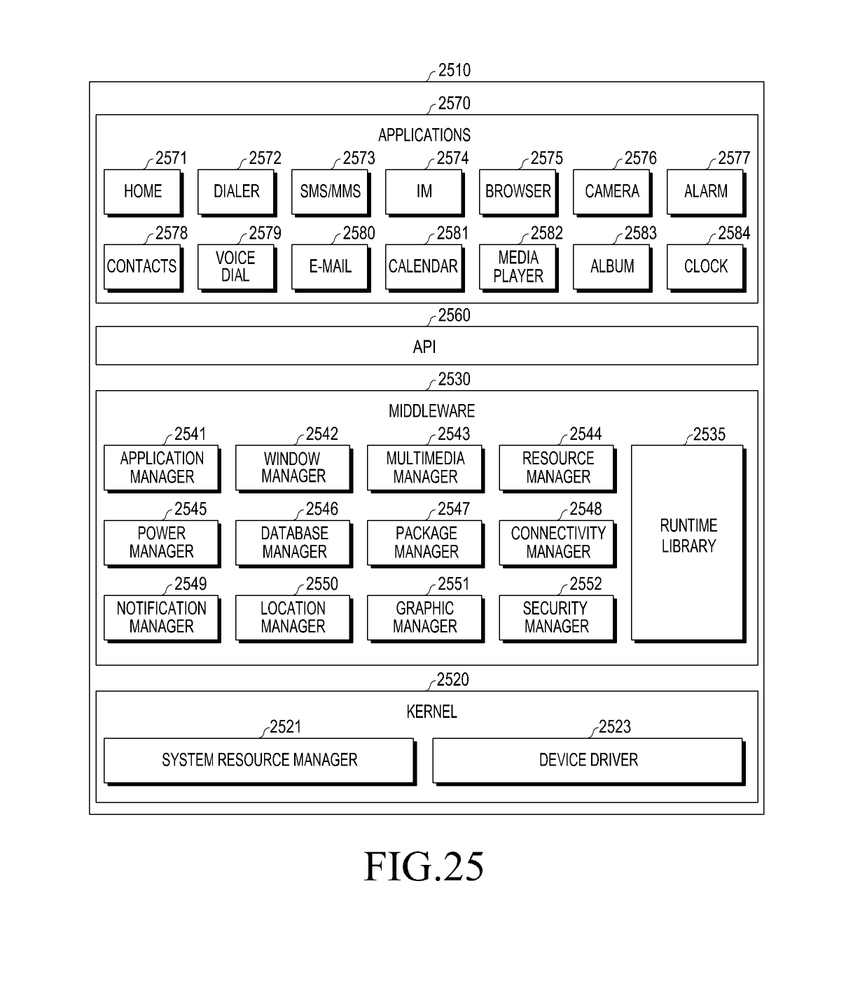

FIG. 25 is a block diagram illustrating an example program module according to various example embodiments.

According to an embodiment, the program module 2510 (for example, the program 140) may include an Operating System (OS) that controls resources relating to an electronic device (for example, the electronic device 101) and/or various applications (for example, the application programs 147) that are executed in the operating system. The operating system may be, for example, Android, iOS, Windows, Symbian, Tizen, Bada, and the like

The program module 2510 may include a kernel 2520, middleware 2530, an Application Programming Interface (API) 2560, and/or applications 2570. At least a part of the program module 2510 may be preloaded on the electronic device, or may be downloaded from an external electronic device (for example, the electronic device 102 or 104 or the server 106).

The kernel 2520 (for example, the kernel 141) may include, for example, a system resource manager 2521 and/or a device driver 2523. The system resource manager 2521 may control, allocate, or retrieve system resources. According to an embodiment, the system resource manager 2521 may include a process manager, a memory manager, or a file system manager. The device driver 2523 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 2530 may provide a function required by the applications 2570 in common or provide various functions to the applications 2570 through the API 2560 so that the applications 2570 can efficiently use limited system resources within the electronic device. According to an embodiment, the middleware 2530 (for example, the middleware 143) may include, for example, at least one of a runtime library 2535, an application manager 2541, a window manager 2542, a multimedia manager 2543, a resource manager 2544, a power manager 2545, a database manager 2546, a package manager 2547, a connectivity manager 2548, a notification manager 2549, a location manager 2550, a graphic manager 2551, and a security manager 2552.

The runtime library 2535 may include, for example, a library module that a compiler uses in order to add a new function through a programming language while the applications 2570 are being executed. The runtime library 2535 may perform input/output management, memory management, the functionality for an arithmetic function, and the like.

The application manager 2541 may manage, for example, the life cycle of at least one of the applications 2570. The window manager 2542 may manage Graphical User Interface (GUI) resources used on a screen. The multimedia manager 2543 may determine formats required to reproduce various media files and may encode or decode a media file using a coder/decoder (codec) appropriate for the corresponding format. The resource manager 2544 may manage resources, such as the source code, the memory, the storage space, and the like of at least one of the applications 2570.

The power manager 2545 may operate together with a Basic Input/Output System (BIOS) to manage a battery or power and may provide power information required for the operation of the electronic device. The database manager 2546 may generate, search for, and/or change a database to be used by at least one of the applications 2570. The package manager 2547 may manage the installation or update of an application that is distributed in the form of a package file.

The connectivity manager 2548 may manage a wireless connection, such as Wi-Fi, Bluetooth, and the like. The notification manager 2549 may display or notify of an event, such as an arrival message, an appointment, a proximity notification, and the like in such a manner as not to disturb a user. The location manager 2550 may manage the location information of the electronic device. The graphic manager 2551 may manage a graphic effect to be provided to a user and a user interface relating to the graphic effect. The security manager 2552 may provide various security functions required for system security, user authentication, and the like. According to an embodiment, in a case where the electronic device (for example, the electronic device 101) has a telephone call function, the middleware 2530 may further include a telephony manager for managing a voice or video call function of the electronic device.

The middleware 2530 may include a middleware module that forms a combination of various functions of the above-described elements. The middleware 2530 may provide specialized modules according to the types of operating systems in order to provide differentiated functions. Furthermore, the middleware 2530 may dynamically remove some of the existing elements, or may add new elements.

The API 2560 (for example, the API 145) is, for example, a set of API programming functions, and may be provided with different configurations according to operating systems. For example, in the case of Android or iOS, one API set may be provided for each platform, and in the case of Tizen, two or more API sets may be provided for each platform.

The applications 2570 (for example, the application program 147) may include, for example, one or more applications which can provide functions such as home 2571, dialer 2572, SMS/MMS 2573, Instant Message (IM) 2574, browser 2575, camera 2576, alarm 2577, contacts 2578, voice dial 2579, email 2580, calendar 2581, media player 2582, album 2583, clock 2584, health care (for example, measure exercise quantity or blood sugar), or environment information (for example, atmospheric pressure, humidity, or temperature information).

According to an embodiment, the applications 2570 may include an application (hereinafter, referred to as an “information exchange application” for convenience of description) that supports information exchange between the electronic device (for example, the electronic device 101) and an external electronic device (for example, the electronic device 102 or 104). The information exchange application may include, for example, a notification relay application for transferring specific information to an external electronic device or a device management application for managing an external electronic device.

For example, the notification relay application may include a function of delivering, to the external electronic device (for example, the electronic device 102 or 104), notification information generated by other applications (for example, an SMS/MMS application, an email application, a health care application, an environmental information application, and the like) of the electronic device 101. Furthermore, the notification relay application may, for example, receive notification information from the external electronic device and may provide the received notification information to a user.

The device management application may manage (for example, install, delete, or update), for example, at least one function of an external electronic device (for example, the electronic device 102 or 104) that communicates with the electronic device (for example, a function of turning on/off the external electronic device itself (or some components thereof) or a function of adjusting the brightness (or resolution) of a display), applications that operate in the external electronic device, or services (for example, a call service, a message service, and the like) that are provided by the external electronic device.

According to an embodiment, the applications 2570 may include applications (for example, a health care application of a mobile medical appliance, and the like) that are specified according to attributes of an external electronic device (for example, the electronic device 102 or 104). According to an embodiment, the applications 2570 may include applications that are received from an external electronic device (for example, the server 106, or the electronic device 102 or 104). According to an embodiment, the applications 2570 may include preloaded applications or third-party applications that can be downloaded from a server. Names of the elements of the program module 2510, according to the above-described embodiments of the present disclosure, may change depending on the type of OS.

According to various embodiments, at least a part of the program module 2510 may be implemented in software, firmware, hardware, or a combination of two or more thereof. At least a part of the program module 2510 may be implemented (for example, executed) by, for example, a processor (for example, the processor 210). At least a part of the program module 2510 may include, for example, a module, a program, a routine, a set of instructions, and/or a process for performing one or more functions.

What is claimed is:

1. A wearable electronic device comprising:
a display unit comprising a display included in a body of the wearable electronic device;
a touch sensor module comprising touch sensing circuitry located to surround the display unit and configured to detect a touch; and
a processor configured to perform a preset operation based on a start position of the touch detected by the touch sensing circuitry and a movement direction of the touch.

2. The wearable electronic device of claim 1, wherein the display comprises a touch screen.

3. The wearable electronic device of claim 1, wherein the processor is configured to perform a preset operation based on a number of touches detected by the touch sensing circuitry.

4. The wearable electronic device of claim 1, wherein, when the start position of the touch is detected on a left side of a vertical line passing a center of the display unit, the processor is configured to perform a scroll up operation when the movement direction of the touch is a clockwise direction and to perform a scroll down operation when the movement direction is a counterclockwise direction.

5. The wearable electronic device of claim 1, wherein, when the start position of the touch is detected on a right side of a vertical line passing a center of the display unit, the processor is configured to perform a scroll down operation when the movement direction of the touch is a clockwise direction and to perform a scroll up operation when the movement direction is a counterclockwise direction.

6. The wearable electronic device of claim 1, wherein, when the start position of the touch is detected on an upper side of a horizontal line passing a center of the display unit, the processor is configured to perform a scroll to right operation when the movement direction of the touch is a clockwise direction and to perform a scroll to left operation when the movement direction is a counterclockwise direction.

7. The wearable electronic device of claim 1, wherein, when the start position of the touch is detected on a lower side of a horizontal line passing a center of the display unit, the processor is configured to perform a scroll to left operation when the movement direction of the touch is a clockwise direction and to perform a scroll to right operation when the movement direction is a counterclockwise direction.

8. The wearable electronic device of claim 1, wherein, when the start position of the touch is detected on a left side of a vertical line passing a center of the display unit, the processor is configured to perform a volume up operation when the movement direction of the touch is a clockwise direction and to perform a volume down operation when the movement direction is a counterclockwise direction.

9. The wearable electronic device of claim 1, wherein, when the start position of the touch is detected on a right side of a vertical line passing a center of the display unit, the processor is configured to perform a volume down operation when the movement direction of the touch is a clockwise direction and to perform a volume up operation when the movement direction is a counterclockwise direction.

10. A wearable electronic device comprising:
a display unit comprising a display included in a body of the wearable electronic device;
a touch sensor module comprising touch sensing circuitry and located to surround the display unit and configured to detect a touch;
a rotation detection unit comprising a rotation decection circuit coupled to the body to be physically rotatable, located at a position corresponding to the touch sensor module, and configured to detect a rotation; and
a processor configured to perform a preset operation based on a start position of the touch detected by the touch sensor module and a direction of the rotation detected by the rotation detection unit.

11. The wearable electronic device of claim 10, wherein the display comprises a touch screen.

12. The wearable electronic device of claim 10, wherein the touch sensor module is rotatable together with the rotation detection unit.

13. The wearable electronic device of claim 10, wherein the processor is configured to perform a preset operation based on a number of touches detected by the touch sensing circuitry.

14. The wearable electronic device of claim 10, wherein, when a start position of the touch is detected on a left side of a vertical line passing a center of the display unit, the processor is configured to perform a scroll up operation when the movement direction of the touch is a clockwise direction and to perform a scroll down operation when the movement direction is a counterclockwise direction.

15. The wearable electronic device of claim 10, wherein, when the start position of the touch is detected on a right side of a vertical line passing a center of the display unit, the processor is configured to perform a scroll down operation when the movement direction of the touch is a clockwise direction and to perform a scroll up operation when the movement direction is a counterclockwise direction.

16. The wearable electronic device of claim 10, wherein, when the start position of the touch is detected on an upper side of a horizontal line passing a center of the display unit, the processor is configured to perform a scroll to right operation when the movement direction of the touch is a clockwise direction and to perform a scroll to left operation when the movement direction is a counterclockwise direction.

17. The wearable electronic device of claim 10, wherein, when the start position of the touch is detected on a lower side of a horizontal line passing a center of the display unit, the processor is configured to perform a scroll to left operation when the movement direction of the touch is a clockwise direction and to perform a scroll to right operation when the movement direction is a counterclockwise direction.

18. The wearable electronic device of claim 10, wherein, when the start position of the touch is detected on a left side of a vertical line passing a center of the display unit, the processor is configured to perform a volume up operation when the movement direction of the touch is a clockwise direction and to perform a volume down operation when the movement direction is a counterclockwise direction.

19. The wearable electronic device of claim 10, wherein, when the start position of the touch is detected on a right side of a vertical line passing a center of the display unit, the processor is configured to perform a volume down operation when the movement direction of the touch is a clockwise direction and to perform a volume up operation when the movement direction is a counterclockwise direction.

20. A method of operating a wearable electronic device, the method comprising:
detecting a touch by touch sensing circuitry of a touch sensor module located to surround a display unit comprising a display included in a body of the wearable electronic device;
determining a start position of the touch detected by the touch sensor module;
determining a movement direction of the touch; and
performing a function corresponding to a currently executed application based on the start position and the movement direction of the touch.
